(19) United States
(12) Patent Application Publication
(10) Pub. No.: US 2026/0364802 A1
(43) Pub. Date: Nov. 19, 2026

(54) SYSTEM AND METHOD FOR ROBOTIC CAMERA ALIGNMENT

(71) Applicant: TOYOTA RESEARCH INSTITUTE, INC., Los Altos, CA (US)

(72) Inventor: Isabella HUANG, San Jose, CA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 19/319,377

(22) Filed: Sep. 4, 2025

Related U.S. Application Data
(60) Provisional application No. 63/805,403, filed on May 14, 2025.

(51) Int. Cl. B25J 9/16; G06T 7/33; G06T 7/73; G06V 10/25; G06V 10/26; G06V 20/64

(52) U.S. Cl. CPC B25J 9/1692; G06T 7/337; G06T 7/74; G06V 10/25; G06V 10/26; G06V 20/64; G06T 2207/10028

(57) ABSTRACT

A method for operation of a robot is described. The method includes detecting a misalignment between a point cloud captured by a chassis camera a point cloud captured by a head camera of the robot. The method also includes computing a relative transformation according to a registration between the point cloud captured by the chassis camera and the point cloud captured by the head camera. The method further includes realigning the chassis camera and the head camera according to the relative transformation.

### CROSS-REFERENCE TO RELATED APPLICATION

The present application claims the benefit of U.S. Provisional Patent Application No. 63/805,403, filed May 14, 2025, and titled “PRACTICAL INSIGHTS ON GRASP STRATEGIES FOR MOBILE MANIPULATION IN THE WILD,” the disclosure of which is expressly incorporated herein by reference in its entirety.

### BACKGROUND

### Field

Certain aspects of the present disclosure relate to machine learning and, more particularly, a system and method for robotic camera alignment.

### BACKGROUND

Autonomous agents (e.g., robots, etc.) rely on machine vision for sensing a surrounding environment by analyzing areas of interest in images of the surrounding environment. Although scientists have spent decades studying the human visual system, a solution for realizing equivalent machine vision remains elusive. Realizing equivalent machine vision is a goal for enabling truly autonomous agents. Machine vision is distinct from the field of digital image processing because of the desire to recover a three-dimensional (3D) structure of the world from images and using the 3D structure for fully understanding a scene. That is, machine vision strives to provide a high-level understanding of a surrounding environment, as performed by the human visual system.

Grasping and placing of a large diversity of novel items is a fundamental problem in mobile robotic manipulation that is specified for robots to be useful in real-world settings, such as a home. Significant progress has been made over the past decade, showing mobile robotic manipulators grasping a diversity of items in lab settings. Unfortunately, many grasping works abstract away different parts of the robot stack, leading to assumptions that do not hold in the real world (e.g., perfect perception, known obstacle geometries, etc.). Furthermore, due to imperfect kinematic calibration or disturbances caused by accidental collisions, the separate head and chassis cameras of a robot may not align perfectly by default. Alignment, however, is crucial when the grasp depends on perception from multiple sources (e.g., item detection from the chassis cameras but tool pose correction from the head cameras). As a result, the robot may be imprecise in movements that require high precision. A system and method for robotic camera alignment, is desired.

### SUMMARY

A method for operation of a robot is described. The method includes detecting a misalignment between a point cloud captured by a chassis camera a point cloud captured by a head camera of the robot. The method also includes computing a relative transformation according to a registration between the point cloud captured by the chassis camera and the point cloud captured by the head camera. The method further includes realigning the chassis camera and the head camera according to the relative transformation.

A non-transitory computer-readable medium having program code recorded thereon for operation of a robot is described. The program code is executed by a processor. The non-transitory computer-readable medium includes program code to detect a misalignment between a point cloud captured by a chassis camera a point cloud captured by a head camera of the robot. The non-transitory computer-readable medium also includes program code to compute a relative transformation according to a registration between the point cloud captured by the chassis camera and the point cloud captured by the head camera. The non-transitory computer-readable medium further includes program code to realign the chassis camera and the head camera according to the relative transformation.

A robot system is described. The robot system includes a chassis having a chassis camera, a head coupled to the chassis and having a head camera, and a manipulator tool coupled to the chassis. The robot system also includes a point cloud misalignment module to detect a misalignment between a point cloud captured by the chassis camera a point cloud captured by the head camera of a robot. The robot system further includes a point cloud relative transformation module to compute a relative transformation according to a registration between the point cloud captured by the chassis camera and the point cloud captured by the head camera. The robot system also includes a camera alignment module to realign the chassis camera and the head camera according to the relative transformation.

This has outlined, broadly, the features and technical advantages of the present disclosure in order that the detailed description that follows may be better understood. Additional features and advantages of the present disclosure will be described below. It should be appreciated by those skilled in the art that the present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a system and method for robotic camera alignment for an autonomous mobile manipulation robot using a system-on-a-chip (SOC) of a robot, in accordance with aspects of the present disclosure.

FIG. 2 is a block diagram illustrating a software architecture for robotic camera alignment of the autonomous mobile manipulation robot of FIG. 1, according to aspects of the present disclosure.

FIG. 3 is a diagram illustrating an example of a hardware implementation of camera alignment for an autonomous mobile manipulation system, according to various aspects of the present disclosure.

FIG. 4 is a block diagram illustrating a modular, interconnected software system for an autonomous mobile manipulation robot, according to various aspects of the present disclosure.

FIG. 5 is a block diagram further illustrating the grasp planner module shown in FIG. 4, according to various aspects of the present disclosure.

FIGS. 6A and 6B, are block diagrams illustrating point cloud alignment, according to various aspects of the present disclosure.

FIG. 7 is a flowchart illustrating a method for operation of an autonomous mobile manipulation robot, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. Any aspect of the present disclosure disclosed may be embodied by one or more elements of a claim.

Although aspects are described herein, many variations and permutations of these aspects fall within the scope of the present disclosure. Although some benefits and advantages of the preferred aspects are mentioned, the scope of the present disclosure is not intended to be limited to benefits, uses, or objectives. Rather, aspects of the present disclosure are intended to be universally applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

Autonomous agents (e.g., robots, etc.) rely on machine vision for sensing a surrounding environment by analyzing areas of interest in images of the surrounding environment. Although scientists have spent decades studying the human visual system, a solution for realizing equivalent machine vision remains elusive. Realizing equivalent machine vision is a goal for enabling truly autonomous agents. Machine vision is distinct from the field of digital image processing because of the desire to recover a three-dimensional (3D) structure of the world from images and using the 3D structure for fully understanding a scene. That is, machine vision strives to provide a high-level understanding of a surrounding environment, as performed by the human visual system.

Grasping and placing of a large diversity of novel items is a fundamental problem in mobile robotic manipulation that is specified for robots to be useful in real-world settings, such as a home. Significant progress has been made over the past decade, showing mobile robotic manipulators grasping a diversity of items in lab settings. Unfortunately, many grasping works abstract away different parts of the robot stack, leading to assumptions that do not hold in the real world (e.g., perfect perception, known obstacle geometries, etc.). Furthermore, due to imperfect kinematic calibration or disturbances caused by accidental collisions, point clouds generated by the separate head and chassis cameras of the robot may not align perfectly by default. Alignment, however, is crucial when the grasp depends on perception from multiple sources (e.g., item detection from the chassis cameras but tool pose correction from the head cameras). As a result, the robot may be imprecise in movements that involve high precision. A system and method for robotic camera alignment, is desired.

Various aspects of the present disclosure are directed to a real-time calibration process for a grasping pipeline for an autonomous mobile manipulation robot. Some implementations are directed to improving grasping by a robotic manipulator within a diverse real-world setting, such as a grocery store. This implementation may focus on calibration between separate cameras of the robot in order to facilitate accurate movement of a manipulator of the autonomous mobile manipulation robot. Various aspects of the present disclosure improve grasping by a robotic manipulator within a diverse real-world setting, such as a grocery store. In particular, these aspects of the present disclosure involve calibration between separate cameras of the robot in order to facilitate accurate movement of a manipulator tool for grasping an object of interest.

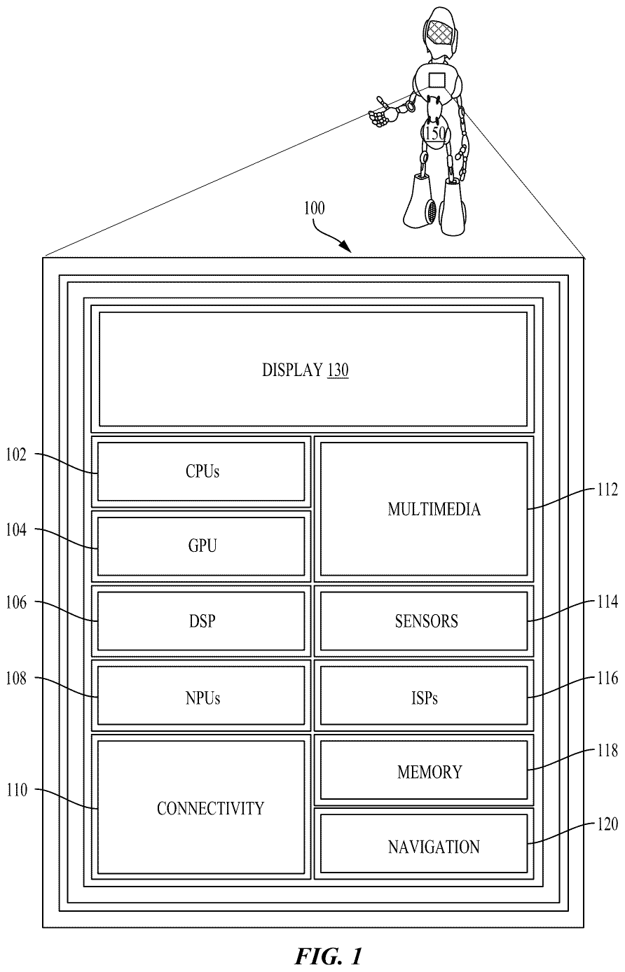

FIG. 1 illustrates an example implementation of a system and method for robotic camera alignment using a system-on-a-chip (SOC) 100 of an autonomous mobile manipulation robot 150, in accordance with aspects of the present disclosure. The SOC 100 may include a single processor or multi-core processors (e.g., a central processing unit), in accordance with certain aspects of the present disclosure. Variables (e.g., neural signals and synaptic weights), system parameters associated with a computational device (e.g., neural network with weights), delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include sixth generation (6G) connectivity, sixth generation (6G) new radio (NR) connectivity, fourth generation long term evolution (4G LTE) connectivity, unlicensed Wi-Fi connectivity, USB connectivity, Bluetooth® connectivity, and the like. In addition, a multimedia processor 112 in combination with a display 130 may, for example, classify and categorize poses of a humanoid robot, according to the display 130 (e.g., an augmented reality (AR) head mounted display (HMD) illustrating a view of the robot 150. In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system.

The SOC 100 may be based on an Advanced Risc Machine (ARM) instruction set, RISC-V, or any reduced instruction set computing (RISC) architecture, or the like. In another aspect of the present disclosure, the SOC 100 may be a server computer in communication with the robot 150. In this arrangement, the robot 150 may include a processor and other features of the SOC 100. In this aspect of the present disclosure, instructions loaded into a processor (e.g., the CPU 102) or the NPU 108 of the robot 150 may include code for camera alignment (e.g., of the robot 150) to enable improve object grasps of the robot 150 from images captured by the sensor processor 114 of the robot 150.

The instructions loaded into a processor (e.g., the CPU 102) may also include code to detect a misalignment between a point cloud captured by a chassis camera a point cloud captured by a head camera of the robot. The instructions loaded into a processor (e.g., the CPU 102) may further include code to compute a relative transformation according to a registration between the point cloud captured by the chassis camera and the point cloud captured by the head camera. The instructions loaded into a processor (e.g., the CPU 102) may also include code to realign the chassis camera and the head camera according to the relative transformation. Accordingly, an object point cloud of surroundings of the robot including a requested object is generated using the chassis camera. Additionally, a tool point cloud of a location of a manipulator tool of the robot is generated using the head camera following alignment of the head and chassis camera. The instructions loaded into a processor (e.g., the CPU 102) may further include code to plan a grasp of the object using the manipulator tool according to a 3D location of the object and a 3D location of the manipulator tool.

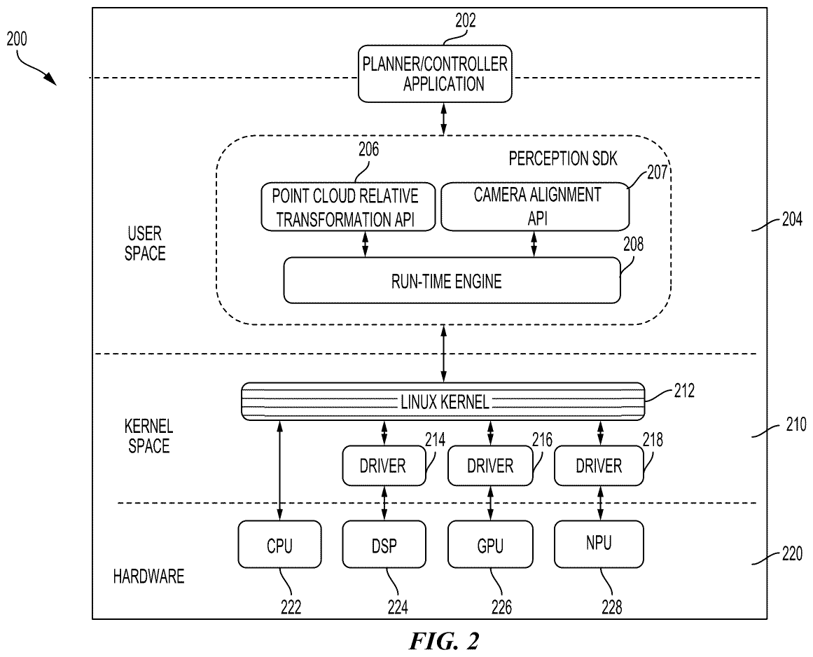

FIG. 2 is a block diagram illustrating a software architecture 200 for robotic camera alignment of the autonomous mobile manipulation robot 150 of FIG. 1, according to aspects of the present disclosure. Using the software architecture 200, a planner/controller application 202 may be designed such that it may cause various processing blocks of a system-on-a-chip (SOC) 220 (for example a CPU 222, a DSP 224, a GPU 226, and/or an NPU 228) to perform supporting computations during run-time operation of the planner/controller application 202.

The planner/controller application 202 may be configured to call functions defined in a user space 204 that may, for example, provide camera alignment for robotic object grasp functionality. In various aspects of the present disclosure, the planner/controller application 202 may make a request to compile program code associated with a library defined in a point cloud relative transformation application programming interface (API) 206 to detect a misalignment between a point cloud captured by a chassis camera a point cloud captured by a head camera of the robot 150. The point cloud relative transformation API 206 may compute a relative transformation according to a registration between the point cloud captured by the chassis camera and the point cloud captured by the head camera.

In various aspects of the present disclosure, the planner/controller application 202 may further make a request to compile program code associated with a library defined in a camera alignment API 207 to realign the chassis camera and the head camera according to the relative transformation. The camera alignment API 207 may enable pose correction of the robot 150 to provide improved object grasp functionality. The camera alignment API 207 may further plan a grasp of the object using the manipulator tool according to a 3D location of an object of interest and a 3D location of the manipulator tool of the robot 150.

A run-time engine 208, which may be compiled code of a run-time framework, may be further accessible to the planner/controller application 202. The planner/controller application 202 may cause the run-time engine 208, for example, to perform camera alignment for refinement of tool pose correction of an autonomous mobile manipulation robot. When tool pose correction is performed for the autonomous mobile manipulation robot, the run-time engine 208 may in turn send a signal to an operating system 210, such as a Linux Kernel 212, running on the SOC 220. The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, the deep neural network may be configured to run on a combination of processing blocks, such as the CPU 222 and the GPU 226, or may be run on the NPU 228 if present.

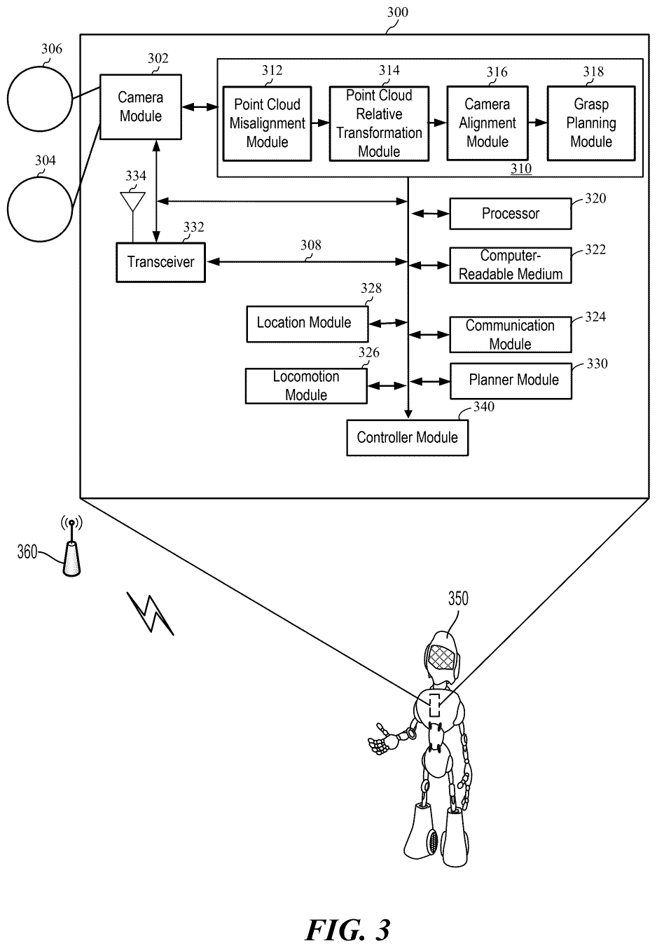

FIG. 3 is a diagram illustrating an example of a hardware implementation of camera alignment for an autonomous mobile manipulation system 300, according to various aspects of the present disclosure. The autonomous mobile manipulation system 300 may be configured for camera alignment of a robot 350 in response to images from a chassis camera and a head camera during operation of the robot 350. The autonomous mobile manipulation system 300 may be a component of a robotic or other autonomous device. For example, as shown in FIG. 3, the autonomous mobile manipulation system 300 is a component of the robot 350. Aspects of the present disclosure are not limited to the autonomous mobile manipulation system 300 being a component of the robot 350, as other devices, such as an autonomous vehicle, a bus, a motorcycle, or other like autonomous vehicles, are also contemplated for using the autonomous mobile manipulation system 300. The robot 350 may be autonomous or semi-autonomous.

The autonomous mobile manipulation system 300 may be implemented with an interconnected architecture, such as a controller area network (CAN) bus, represented by an interconnect 308. The interconnect 308 may include any number of point-to-point interconnects, buses, and/or bridges depending on the specific application of the autonomous mobile manipulation system 300 and the overall design constraints of the robot 350. The interconnect 308 links together various circuits, including one or more processors and/or hardware modules, represented by a camera module 302, a tool pose correction module 310, a processor 320, a computer-readable medium 322, a communication module 324, a locomotion module 326, a location module 328, a planner module 330, and a controller module 340. The interconnect 308 may also link various other circuits such as timing sources, peripherals, voltage regulators, and power management circuits, which are well known in the art, and therefore, will not be described any further.

The autonomous mobile manipulation system 300 includes a transceiver 332 coupled to the camera module 302, the tool pose correction module 310, the processor 320, the computer-readable medium 322, the communication module 324, the locomotion module 326, the location module 328, a planner module 330, and the controller module 340. The transceiver 332 is coupled to an antenna 334. The transceiver 332 communicates with various other devices over a transmission medium. For example, the transceiver 332 may receive commands via transmissions from a user or a remote device. As discussed herein, the user may be in a location that is remote from the location of the robot 350. As another example, the transceiver 332 may transmit robotic state information from the tool pose correction module 310 to a server (not shown).

The autonomous mobile manipulation system 300 includes the processor 320 coupled to the computer-readable medium 322. The processor 320 performs processing, including the execution of software stored on the computer-readable medium 322 to provide camera alignment for robotic object grasp functionality, according to the present disclosure. The software, when executed by the processor 320, causes the autonomous mobile manipulation system 300 to perform the various functions described for robotic object grasp with a surrounding environment from scenes in video captured by a chassis camera and a head camera of an autonomous agent, such as the robot 350, or any of the modules (e.g., 302, 310, 324, 326, 328, 330, and/or 340). The computer-readable medium 322 may also be used for storing data that is manipulated by the processor 320 when executing the software.

The camera module 302 may obtain images via different cameras, such as a chassis camera 304 and a head camera 306. The chassis camera 304 and the head camera 306 may be a vision sensor (e.g., a stereoscopic camera or a red-green-blue (RGB) camera) for capturing 2D RGB images. Alternatively, the camera module may be coupled to a ranging sensor, such as a light detection and ranging (LIDAR) sensor or a radio detection and ranging (RADAR) sensor. Of course, aspects of the present disclosure are not limited to the sensors, as other types of sensors (e.g., thermal, sonar, and/or lasers) are also contemplated for either of the chassis camera 304 or the head camera 306.

The images of the chassis camera 304 and/or the head camera 306 may be processed by the processor 320, the camera module 302, the tool pose correction module 310, the communication module 324, the locomotion module 326, the location module 328, and the controller module 340. In conjunction with the computer-readable medium 322, the images from the chassis camera 304 and/or the head camera 306 are processed to implement the functionality described herein. In one configuration, detected 2D object information captured by the chassis camera 304 and/or the head camera 306 may be transmitted via the transceiver 332. The chassis camera 304 and the head camera 306 may be coupled to the robot 350 or may be in communication with the robot 350.

The location module 328 may determine a location of the robot 350 using simultaneous localization and mapping (SLAM). Alternatively, the location module 328 may use a global positioning system (GPS) to determine the location of the robot 350. The location module 328 may implement a dedicated short-range communication (DSRC)-compliant GPS unit. A DSRC-compliant GPS unit includes hardware and software to make the robot 350 and/or the location module 328 compliant with one or more of the following DSRC standards, including any derivative or fork thereof: EN 12253:2004 Dedicated Short-Range Communication—Physical layer using microwave at 5.9 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); EN 13372:2004 Dedicated Short-Range Communication (DSRC)—DSRC profiles for RTTT applications (review); and EN ISO 14906:2004 Electronic Fee Collection—Application interface.

A DSRC-compliant GPS unit within the location module 328 is operable to provide GPS data describing the location of the robot 350 with space-level accuracy for accurately directing the robot 350 to a desired location. For example, the robot 350 is moving to a predetermined location and desires partial sensor data. Space-level accuracy means the location of the robot 350 is described by the GPS data sufficient to confirm a location of the robot 350 parking space. That is, the location of the robot 350 is accurately determined with space-level accuracy based on the GPS data from the robot 350.

The communication module 324 may facilitate communications via the transceiver 332. For example, the communication module 324 may be configured to provide communication capabilities via different wireless protocols, such as Wi-Fi, long term evolution (LTE), 3G, etc. The communication module 324 may also communicate with other components of the robot 350 that are not modules of the autonomous mobile manipulation system 300. The transceiver 332 may be a communications channel through a network access point 360. The communications channel may include DSRC, LTE, LTE-D2D, mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

In some configurations, the network access point 360 includes Bluetooth® communication networks or a cellular communications network for sending and receiving data, including via short messaging service (SMS), multimedia messaging service (MMS), hypertext transfer protocol (HTTP), direct data connection, wireless application protocol (WAP), e-mail, DSRC, full-duplex wireless communications, mmWave, Wi-Fi (infrastructure mode), Wi-Fi (ad-hoc mode), visible light communication, TV white space communication, and satellite communication. The network access point 360 may also include a mobile data network that may include 3G, 4G, 5G, 6G, LTE, LTE-V 2X, LTE-D 2D, VoLTE, or any other mobile data network or combination of mobile data networks. Further, the network access point 360 may include one or more IEEE 802.11 wireless networks.

The autonomous mobile manipulation system 300 also includes the planner module 330 for planning a selected trajectory to perform a route/action (e.g., collision avoidance) of the robot 350 and the controller module 340 to control the locomotion of the robot 350. The controller module 340 may perform the selected action via the locomotion module 326 for autonomous operation of the robot 350 along, for example, a selected route. In one configuration, the planner module 330 and the controller module 340 may collectively override a user input when the user input is expected (e.g., predicted) to cause a collision according to an autonomous level of the robot 350. The modules may be software modules running in the processor 320, resident/stored in the computer-readable medium 322, and/or hardware modules coupled to the processor 320, or some combination thereof.

The National Highway Traffic Safety Administration (NHTSA) has defined different “levels” of autonomous agents (e.g., Level 0, Level 1, Level 2, Level 3, Level 4, and Level 5). For example, if an autonomous agent has a higher-level number than another autonomous agent (e.g., Level 3 is a higher-level number than Levels 2 or 1), then the autonomous agent with a higher-level number offers a greater combination and quantity of autonomous features relative to the agent with the lower-level number. These distinct levels of autonomous agents are described briefly below.

Level 0: In a Level 0 agent, the set of advanced driver assistance system (ADAS) features installed in an agent provide no agent control but may issue warnings to the driver of the agent. An agent which is Level 0 is not an autonomous or semi-autonomous agent.

Level 1: In a Level 1 agent, the driver is ready to take operation control of the autonomous agent at any time. The set of ADAS features installed in the autonomous agent may provide autonomous features such as: adaptive cruise control (ACC); parking assistance with automated steering; and lane keeping assistance (LKA) type II, in any combination.

Level 2: In a Level 2 agent, the driver is obliged to detect objects and events in the roadway environment and respond if the set of ADAS features installed in the autonomous agent fail to respond properly (based on the driver's subjective judgement). The set of ADAS features installed in the autonomous agent may include accelerating, braking, and steering. In a Level 2 agent, the set of ADAS features installed in the autonomous agent can deactivate immediately upon takeover by the driver.

Level 3: In a Level 3 ADAS agent, within known, limited environments (such as freeways), the driver can safely turn their attention away from operation tasks but must still be prepared to take control of the autonomous agent when needed.

Level 4: In a Level 4 agent, the set of ADAS features installed in the autonomous agent can control the autonomous agent in all but a few environments, such as severe weather. The driver of the Level 4 agent enables the automated system (which is comprised of the set of ADAS features installed in the agent) only when it is safe to do so. When the automated Level 4 agent is enabled, driver attention is not required for the autonomous agent to operate safely and consistent within accepted norms.

Level 5: In a Level 5 agent, other than setting the destination and starting the system, no human intervention is involved. The automated system can drive to any location where it is legal to drive and make its own decision (which may vary based on the district where the agent is located).

A highly autonomous agent (HAA) is an autonomous agent that is Level 3 or higher. Accordingly, in some configurations the robot 350 is one of the following: a Level 0 non-autonomous agent; a Level 1 autonomous agent; a Level 2 autonomous agent; a Level 3 autonomous agent; a Level 4 autonomous agent; a Level 5 autonomous agent; and an HAA.

The tool pose correction module 310 may be in communication with the camera module 302, the processor 320, the computer-readable medium 322, the communication module 324, the locomotion module 326, the location module 328, the planner module 330, the transceiver 332, and the controller module 340. In one configuration, the tool pose correction module 310 receives sensor data from the camera module 302. The camera module 302 may receive RGB video image data from the chassis camera 304 and the head camera 306. According to aspects of the present disclosure, the tool pose correction module 310 may receive RGB video image data directly from the chassis camera 304 or the head camera 306 as well as an RGB depth (RGB-D) to explore an environment from images captured by the chassis camera 304 and the head camera 306 of the robot 350. In various aspects of the present disclosure, the planner module 330 and/or the controller module 340 are configured for planning and control of the robot 350 to perform camera alignment for tool pose correction, as follows.

Grasping and placing of a large diversity of novel items is a fundamental problem in mobile robotic manipulation that is specified for robots to be useful in real-world settings, such as a home. Significant progress has been made over the past decade, showing mobile robotic manipulators grasping a diversity of items in lab settings. Unfortunately, many grasping works abstract away different parts of the robot stack, leading to assumptions that do not hold in the real world (e.g., perfect perception, known obstacle geometries, etc.). Furthermore, due to imperfect kinematic calibration or disturbances caused by accidental collisions, point clouds generated by the separate head and chassis cameras of the robot may not align perfectly by default. Alignment, however, is crucial when the grasp depends on perception from multiple sources (e.g., item detection from the chassis cameras but tool pose correction from the head cameras). As a result, the robot may be imprecise in movements that involve high precision. A system and method for robotic camera alignment, is desired.

Various aspects of the present disclosure are directed to a real-time calibration process for a grasping pipeline for an autonomous mobile manipulation robot. Some implementations are directed to improving grasping by a robotic manipulator within a diverse real-world setting, such as a grocery store. This implementation may focus on calibration between separate cameras of the robot in order to facilitate accurate movement of a manipulator of the autonomous mobile manipulation robot.

As shown in FIG. 3, the tool pose correction module 310 includes a point cloud misalignment module 312, a point cloud relative transformation module 314, a camera alignment module 316, and a grasp planning module 318. The point cloud misalignment module 312, the point cloud relative transformation module 314, the camera alignment module 316, and the grasp planning module 318 may be components of a same or different artificial neural network, such as a convolutional neural network (CNN). The modules (e.g., 312, 314, 316, 318) of the tool pose correction module 310 are not limited to a CNN. In operation, the tool pose correction module 310 receives a video stream from the chassis camera 304 and the head camera 306. The video stream may include a two-dimensional (2D) red-green-blue (2D RGB) head image from the chassis camera 304 and a 2D RGB body image from the head camera 306 to provide video frame images. The video stream may include multiple frames, such as image frames.

In some aspects of the present disclosure, the tool pose correction module 310 is configured for providing camera alignment of the robot 350. The tool pose correction module 310 includes the chassis camera 304 to generate an object point cloud of surroundings of the robot including a requested object. Additionally, the tool pose correction module 310 uses the head camera 306 may generate a tool point cloud of a location of a manipulator tool of the robot 350.

Additionally, the tool pose correction module 310 includes the point cloud misalignment module 312 to detect a misalignment between a point cloud captured by a chassis camera a point cloud captured by a head camera of the robot. The tool pose correction module 310 further includes the point cloud relative transformation module 314 compute a relative transformation according to a registration between the point cloud captured by the chassis camera and the point cloud captured by the head camera. The tool pose correction module 310 further includes the camera alignment module 316 realign the chassis camera and the head camera according to the relative transformation.

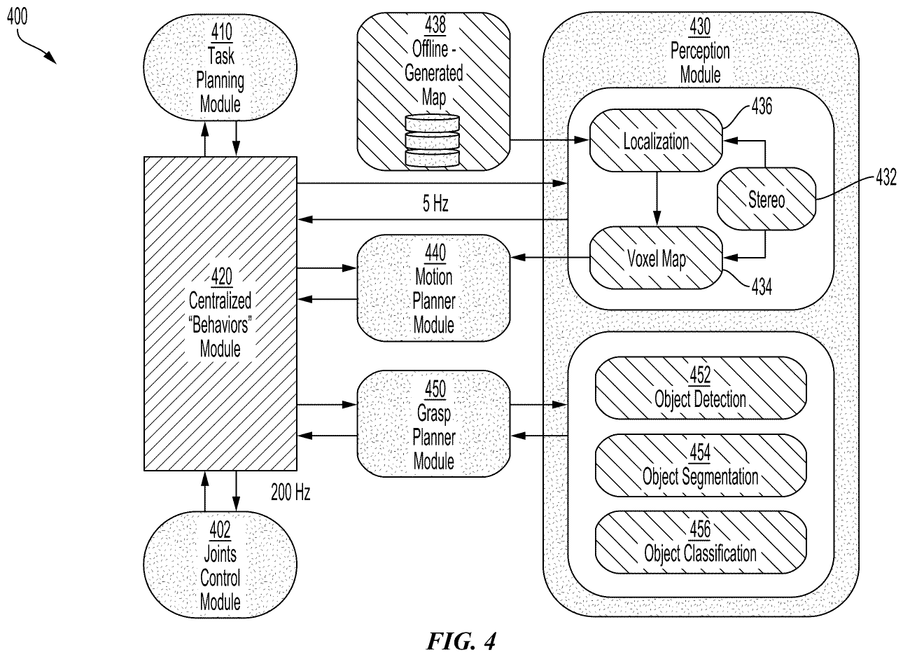

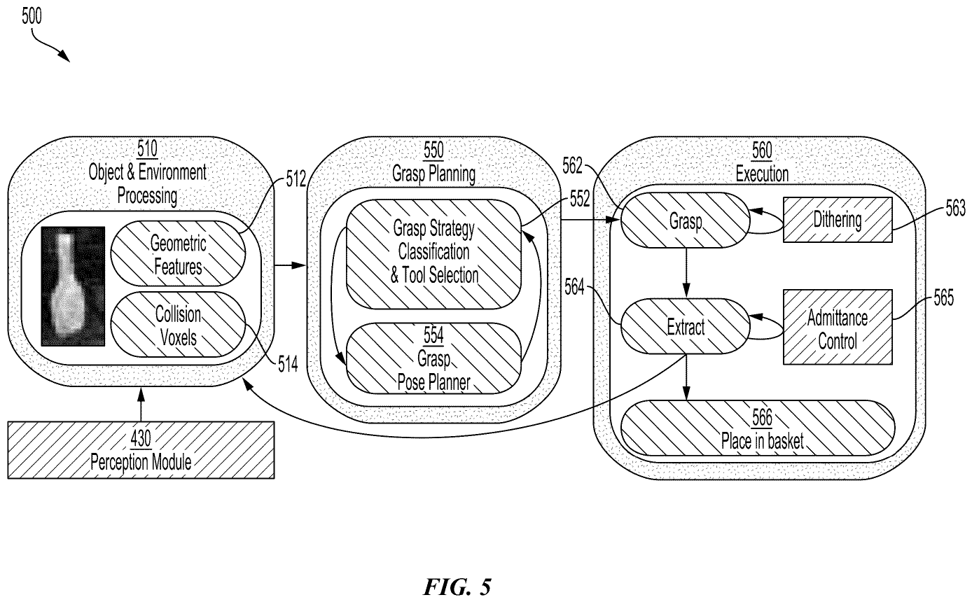

For example, the camera alignment module 316 provides pose correction of the robot 350 to provide improved object grasp functionality. In this example, the tool pose correction module 310 determines a three-dimensional (3D) location of an object of interest and a 3D location of a manipulator tool of the robot 350 once the camera alignment module 316 completes camera alignment. The tool pose correction module 310 further includes the grasp planning module to plan a grasp of the object using the manipulator tool according to the 3D location of the object and the 3D location of the manipulator tool. For example, this operation of the robot 350 to improve tool pose correction is illustrated, for example, in FIGS. 4-5.

FIG. 4 is a block diagram illustrating a modular, interconnected software system for an autonomous mobile manipulation robot, according to various aspects of the present disclosure.

FIG. 4 illustrates a software stack 400, with different modules running at varying rates, all communicating through a custom inter-process communication (IPC) framework. For example, a task planning module 410 operates a hierarchical finite state machine to determine a robot's next high-level action (e.g., navigate to item, detect item, plan grasp). In this example, a centralized behavior module 420 may query a perception module 430, a motion planning module 440 and a grasp planner module 450. In response, the centralized behavior module 420 may transmit low-level actuator commands (e.g., at 200 Hz) to a joint control module 402. Additionally, the perception module 430 runs at a predetermined rate (e.g., 5 Hz) to generate an updated stereo point cloud 432 and voxel map 434 of the surroundings of the robot, while a localization module 436 localizes the robot within an offline-generated map 438.

As shown in FIG. 4, an overall task flow of the robot begins with the motion planning module 440 (e.g., based on the Christofides algorithm) generating a sequence of navigation targets that minimizes the path length specified to visit requested items. A navigation module (e.g., using a variant of the Dynamic Window Approach (DWA)) guides the robot between these points, handling dynamic obstacles and layout changes (relative to the offline-generated map 438). At the start of the task, the robot is localized in the offline-generated map 438. Once localized, the robot may use visual odometry (VO) to update its pose while navigating to each item in a request list. To mitigate VO drift, the robot re-localizes with the offline-generated map 438 each time it arrives at a new item. While the details of navigation and localization are outside the scope of this disclosure, it is assumed that these modules allow the robot to reach the approximate location of any requested item (e.g., within +/−40 cm).

Once the robot has autonomously navigated in front of where it believes the item should be, it calls the perception module 430 to locate the item. If the target item is not in sight, the robot simply moves to the next item in the requested list (e.g., a shopping list). In addition to determining the existence of the target item, the perception module 430 includes an object detection module 452 for estimating a bounding box of an item, computing a segmented point cloud of the item using an object segmentation module 454, and also determining the pose of the item on a center patch of the item.

In this example, the perception module 430, the object detection module 452, an object classification module 456, and the object segmentation module 454. For example, the object detection module 452 is trained on fully synthetic data and outputs bounding boxes around grocery items in the images. In this example, the object classification module 456 then takes the bounding box output and matches the item to an item in an existing database or indicates that no match was found. Additionally, the object segmentation module 454 also takes the bounding box output and segments out the item. As described in further detail below, a grasp planner module 450 utilizes the object detection module 452, the object segmentation module 454, and the object classification module 456 of the perception module 430 for retrieving objects.

FIG. 5 is a block diagram further illustrating the grasp planner module shown in FIG. 4, according to various aspects of the present disclosure.

FIG. 5 illustrates various operations 500 performed following the perception module 430, as shown in FIG. 4. In this example an object and environment processing module 510 extracts relevant geometric features 512 from a segmented point cloud from the perception module 430. Additionally, contextual information about the item's immediate surroundings, such as its fixturing type or potential collision voxels 514 are also extracted from the segmented point cloud computed by the perception module 430. In response, a grasp planning module 550 selects an appropriate grasp strategy classification and a tool selection 552, which varies based on the chosen tool and a grasp pose planner module 554.

According to various aspects of the present disclosure, effective operation of the manipulator and tool of the robot involves system calibration to properly control the tool with precision. This is performed during execution 560, in a grasp 562 (e.g., dithering) from a current location, an extract 564 (e.g., admittance control), and final object placement 566 (e.g., place in a basket) to complete the requested object retrieval. In general, the robot is aware of the location of the manipulator and tool. Unfortunately, a model of the environment is not perfect in relation to the real world due to various kinematic errors that exist. This can result from variations in current to the motors that control the movement of the manipulator, etc.

As shown in FIG. 5, if the grasp 562 (e.g., a suction grasp) is missed during the initial approach due to kinematic imprecision, the robot executes small, probing movements—referred to as dithering 563—around the initial target pose. This process continues until the suction tool detects a pressure signal indicating a successful grasp or until a preset timeout occurs. The motion involves moving the tool back and forth while slightly varying its position in a direction perpendicular to the primary motion. To ensure that the tool does not exert excessive force on the environment, an admittance control 565 is employed as part of the extract 564, which models the tool's motion as a virtual mass-spring-damper system, enabling compliance against external forces.

Robot manipulation in real-world settings is invariably affected by imprecision. This challenge may arise from sensor noise and kinematic errors in the robot's arms and torso. For example, because each kinematic chain has many (e.g., 12) joints from a base of a torso to a gripper, buildup of kinematic error is inevitable. These factors accumulate, ultimately reducing the likelihood of a successful grasp. To address these issues, various aspects of the present disclosure incorporates several mitigation strategies, such as dithering noted in FIG. 5.

As described above, the robot is equipped with two separate cameras. One camera is embedded in the body/torso of the robot (e.g., a chassis camera) and does not move independently. The second camera is mounted in the head of the robot (e.g., a head camera), which does move, and observes the tool/manipulator. In general, the system uses the head camera to generate a point cloud of the surroundings and segments out the tool point cloud in order to know where the object is in reality through visual sensing. The system also simulates/imagines where the tool should be in the 3D space and derives a transform between these that is used to correct the offset. This is part of the dynamic determination of alignment for the tool. For example, this process may involve deriving a transform between the simulated location of the manipulator tool and a captured location of the manipulator tool to identify an offset according to the tool point cloud to perform a dynamic determination of alignment for the manipulator tool.

The problem resolved here is that when the system uses one camera (i.e., the chassis camera) to detect the object and then the other camera (i.e., the head camera) to plan movement of the tool, because, in general, the chassis camera does not have an adequate view of the whole scene. There is a problem with performing the tool alignment as described above because the view of the chassis camera may not capture the tool completely. In order to facilitate the use of the head camera when information is originally derived from the chassis camera, there needs to be precision in knowing the exact location/pose of the head camera. This is done as a pre-configuration step of the robot but when taking a point cloud from each separate camera, there still exists alignment issues that result in errors in the movement.

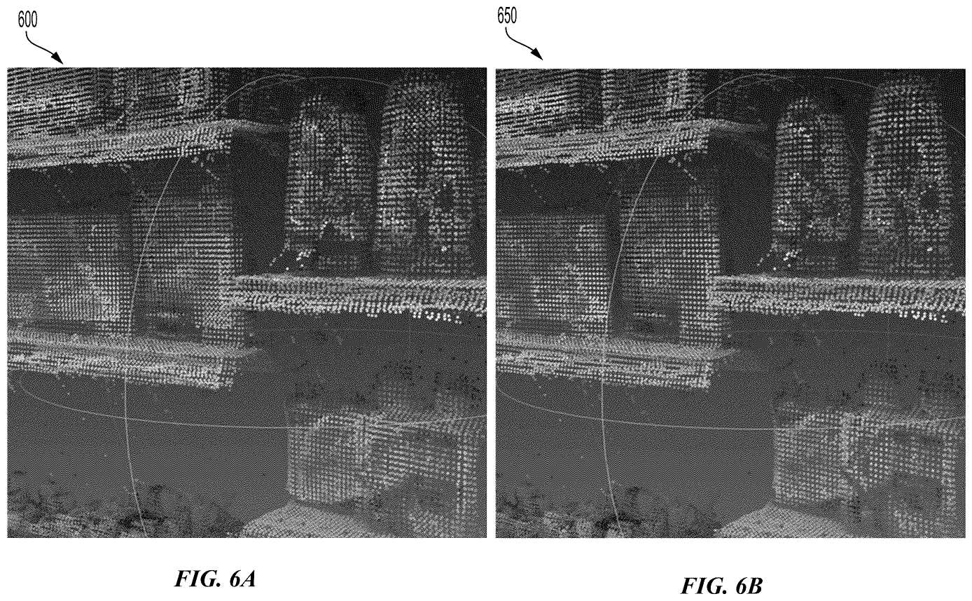

FIGS. 6A and 6B, are block diagrams illustrating point cloud alignment, according to various aspects of the present disclosure. Due to imperfect kinematic calibration or disturbances caused by accidental collisions, the point clouds generated by the head and chassis cameras may not align perfectly by default, as shown by the unaligned point clouds 600, as shown in FIG. 6A. Alignment, however, is crucial when the grasp depends on perception from multiple sources (e.g., item detection from the chassis cameras but tool pose correction from the head cameras). In these cases, an Iterative Closest Point (ICP) algorithm is used to align the point clouds from both sources, alleviating any misalignment, as shown by the aligned point clouds 650, as shown in FIG. 6B.

In one implementation, the system uses iterative closest point (ICP) alignment of the camera sources in real-time. ICP is essentially a registration between the two-point clouds from the separate camera sources where the system correlates the point clouds together. The relative transformation that is derived from this to align the two separate point clouds is essentially an alignment error. This transformation can then be used to refine the adjustment of the tool pose correction, thereby providing for an accurate movement of the tool. For example, a tool relative transformation may be applied to a tool point cloud to form an adjusted tool point cloud and/or an object relative transformation may be applied to an object point cloud to form an adjusted object point cloud. Additional details regarding tool pose correction are omitted, as this implementation involves the correction between the two separate camera sources using, for example, ICP. That is, this implementation is directed to alignment of the two camera sources using ICP as part of a tool pose correction.

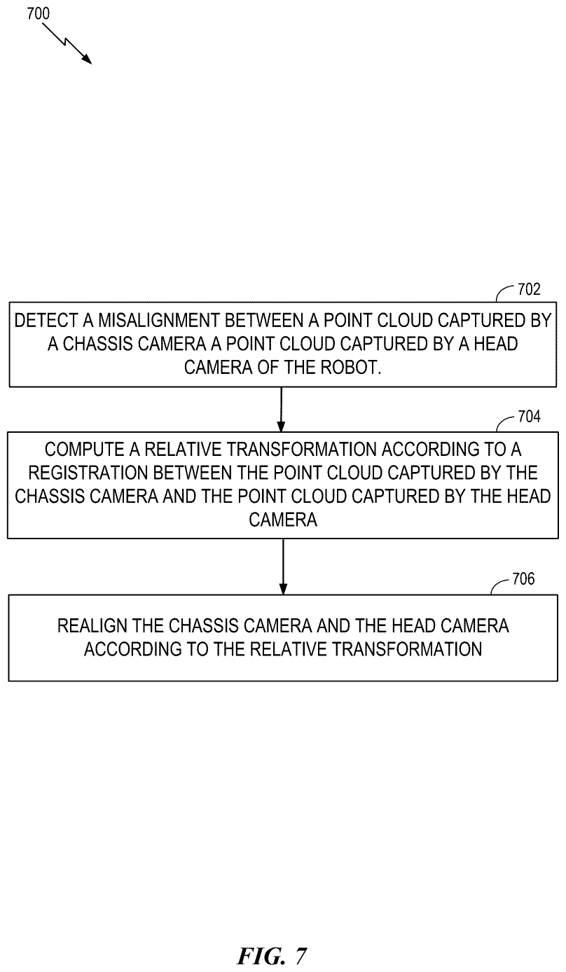

Tool pose correction. Good hardware/calibration can often reduce error in gripper pose to centimeter-level accuracy. However, for many of our grasps, sub-centimeter accuracy is specified for success (e.g. grasping the neck of a bottle). To accomplish this, a kinematic correction at is performed at runtime by comparing the observed point cloud for our gripper to a CAD model of our gripper. In this implementation, point cloud registration is performed to compute a pose delta between the observed point cloud and a reference point cloud (produced by sampling the CAD model of the gripper). For example, the point cloud registration may be performed using a direct, semi-exhaustive search (DSES) method for robust, partial-to-full point cloud registration, which has advantages of being highly robust. This pipeline helps ensure that the grasp pose we command the robot to is accurately achieved. A process of robotic camera alignment is illustrated, for example, in FIG. 7.

FIG. 7 is a flowchart illustrating a method 700 for operation of an autonomous mobile manipulation robot, according to aspects of the present disclosure. The method 700 begins at block 702, in which a misalignment is detected between a point cloud captured by a chassis camera a point cloud captured by a head camera of the robot. For example, Due to imperfect kinematic calibration or disturbances caused by accidental collisions, the point clouds generated by the head and chassis cameras of a robot may not align perfectly by default, as shown by the unaligned point clouds 600, as shown in FIG. 6a.

At block 704, a relative transformation is computed according to a registration between the point cloud captured by the chassis camera and the point cloud captured by the head camera. For example, a robot system use iterative closest point (ICP) alignment of the camera sources in real-time. ICP is essentially a registration between the two-point clouds from the separate camera sources where the system correlates the point clouds together. The relative transformation that is derived from this to align the two separate point clouds is essentially an alignment error. This transformation can then be used to refine the adjustment of the tool pose correction, thereby providing for an accurate movement of the tool.

At block 706, the chassis camera and the head camera are realigned according to the relative transformation. For example, Alignment, however, is crucial when the grasp depends on perception from multiple sources (e.g., item detection from the chassis cameras but tool pose correction from the head cameras). In these cases, an Iterative Closest Point (ICP) algorithm is used to align the point clouds from both sources, alleviating any misalignment, as shown by the aligned point clouds 650, as shown in FIG. 6B.

In some aspects of the present disclosure, the method 700 may be performed by the SOC 100 (FIG. 1) or the software architecture 200 (FIG. 2) of the robot 150 (FIG. 1). That is, each of the elements of method 700 may, for example, but without limitation, be performed by the SOC 100, the software architecture 200, or the processor (e.g., CPU 102) and/or other components included therein of the robot 150.

The various operations of methods described above may be performed by any suitable means capable of performing the corresponding functions. The means may include various hardware and/or software component(s) and/or module(s), including, but not limited to, a circuit, an application-specific integrated circuit (ASIC), or processor. Where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules, and circuits described in connection with the present disclosure may be implemented or performed with a processor configured according to the present disclosure, a digital signal processor (DSP), an ASIC, a field-programmable gate array signal (FPGA) or other programmable logic device (PLD), discrete gate or transistor logic, discrete hardware components, or any combination thereof designed to perform the functions described herein. The processor may be a microprocessor, but in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media may include random access memory (RAM), read-only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits, such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read-only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such with cache and/or specialized register files. Although the various components discussed may be described as having a specific location, such as a local component, they may also be configured in numerous ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an ASIC with the processor, the bus interface, the user interface, supporting circuitry, and at least a portion of the machine-readable media integrated into a single chip, or with one or more PGAs, PLDs, controllers, state machines, gated logic, discrete hardware components, or any other suitable circuitry, or any combination of circuits that can perform the various functions described throughout the present disclosure. Those skilled in the art will recognize how best to implement the described functionality for the processing system depending on the application and the overall design constraints imposed on the overall system.

The machine-readable media may comprise several software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media, including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc; where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for operation of a robot, the method comprising:
detecting a misalignment between a point cloud captured by a chassis camera a point cloud captured by a head camera of the robot;
computing a relative transformation according to a registration between the point cloud captured by the chassis camera and the point cloud captured by the head camera; and
realigning the chassis camera and the head camera according to the relative transformation.

2. The method of claim 1, in which computing comprises:
correlating the point cloud captured by the chassis camera and the point cloud captured by the head camera according to the registration;
computing an alignment error between the point cloud captured by the chassis camera and the point cloud captured by the head camera according to the correlating; and
computing the relative transformation to between the point cloud captured by the chassis camera and the point cloud captured by the head camera according to the alignment error.

3. The method of claim 1, in which realigning further comprises utilizing an iterative closest point (ICP) alignment of the chassis camera and the head camera.

4. The method of claim 1, in which realigning further comprises:
segmenting an object point cloud captured by the chassis camera to identify a three-dimensional (3D) location of an object of interest; and
applying an object relative transformation to form an adjusted 3D object location of the object of interest.

5. The method of claim 4, further comprising computing the object relative transformation between the object point cloud captured by the chassis camera and an object point cloud captured by the head camera.

6. The method of claim 5, further comprising:
segmenting a tool point cloud captured by the head camera to identify a three-dimensional (3D) location of a manipulator tool of the robot; and
applying a tool relative transformation to form an adjusted 3D tool location of the manipulator tool.

7. The method of claim 6, further comprising computing the relative transformation between the tool point cloud captured by the head camera and a tool point cloud captured by the chassis camera.

8. The method of claim 7, further comprising:
planning a grasp of the object using the manipulator tool according to the adjusted 3D location of the object and the adjusted 3D location of the manipulator tool;
grasping the object according to the planning;
extracting the object from the location; and
placing the object in a basket.

9. A non-transitory computer-readable medium having program code recorded thereon for operation of a robot, the program code being executed by a processor and comprising:
program code to detect a misalignment between a point cloud captured by a chassis camera a point cloud captured by a head camera of the robot;
program code to compute a relative transformation according to a registration between the point cloud captured by the chassis camera and the point cloud captured by the head camera; and
program code to realign the chassis camera and the head camera according to the relative transformation.

10. The non-transitory computer-readable medium of claim 9, in which the program code to compute comprises:
program code to correlate the point cloud captured by the chassis camera and the point cloud captured by the head camera according to the registration;
program code to compute an alignment error between the point cloud captured by the chassis camera and the point cloud captured by the head camera according to the correlating; and
program code to compute the relative transformation to between the point cloud captured by the chassis camera and the point cloud captured by the head camera according to the alignment error.

11. The non-transitory computer-readable medium of claim 9, in which the program code to realign further comprises utilize an iterative closest point (ICP) alignment of the chassis camera and the head camera.

12. The non-transitory computer-readable medium of claim 9, in which the program code to realign further comprises:
program code to segment an object point cloud captured by the chassis camera to identify a three-dimensional (3D) location of an object of interest; and
program code to apply an object relative transformation to form an adjusted 3D object location of the object of interest.

13. The non-transitory computer-readable medium of claim 12, further comprising program code to compute the object relative transformation between the object point cloud captured by the chassis camera and an object point cloud captured by the head camera.

14. The non-transitory computer-readable medium of claim 13, further comprising:
program code to segment a tool point cloud captured by the head camera to identify a three-dimensional (3D) location of a manipulator tool of the robot; and
program code to apply a tool relative transformation to form an adjusted 3D tool location of the manipulator tool.

15. The non-transitory computer-readable medium of claim 14, further comprising program code to compute the tool relative transformation between the tool point cloud captured by the head camera and a tool point cloud captured by the chassis camera.

16. The non-transitory computer-readable medium of claim 15, further comprising:
program code to plan a grasp of the object using the manipulator tool according to the adjusted 3D location of the object and the adjusted 3D location of the manipulator tool;
program code to grasp the object according to the planning;
program code to extract the object from the location; and
program code to place the object in a basket.

17. A robot system, the robot system comprising:
a chassis having a chassis camera;
a head coupled to the chassis and having a head camera;
a manipulator tool coupled to the chassis;
a point cloud misalignment module to detect a misalignment between a point cloud captured by the chassis camera a point cloud captured by the head camera of a robot;
a point cloud relative transformation module to compute a relative transformation according to a registration between the point cloud captured by the chassis camera and the point cloud captured by the head camera; and
a camera alignment module to realign the chassis camera and the head camera according to the relative transformation.

18. The robot system of claim 17, in which the camera alignment module is further to utilize an iterative closest point (ICP) alignment of the chassis camera and the head camera.

19. The robot system of claim 17, in which the point cloud relative transformation module is further to compute an object relative transformation between an object point cloud captured by the chassis camera and an object point cloud captured by the head camera and to compute a tool relative transformation between the tool point cloud captured by the head camera and a tool point cloud captured by the chassis camera.

20. The robot system of claim 19, in which the camera alignment module is further to segment a tool point cloud captured by the head camera to identify a three-dimensional (3D) location of the manipulator tool of the robot, to apply the computed tool relative transformation to form an adjusted 3D tool location of the manipulator tool, to segment an object point cloud captured by the chassis camera to identify a three-dimensional (3D) location of an object of interest, and to apply the computed object relative transformation to form an adjusted 3D object location of the object of interest; and further comprising:
a grasp planning module to plan a grasp of the object using the manipulator tool according to the adjusted 3D location of the object and the adjusted 3D location of the manipulator tool.
